(19) United States
(12) Patent Application Publication
(10) Pub. No.: US 2022/0080529 A1
(43) Pub. Date: Mar. 17, 2022

(54) OPTIMIZED LASER CUTTING PROCESS FOR WAVEGUIDE GLASS SUBSTRATE

(71) Applicant: Snap Inc., Santa Monica, CA (US)

(72) Inventors: Benamanahalli K. Nagaraj, Manhattan Beach, CA (US); Amit Singh, Los Angeles, CA (US); David Fliszar, Manhattan Beach, CA (US)

(21) Appl. No.: 17/459,112

(22) Filed: Aug. 27, 2021

Related U.S. Application Data
(60) Provisional application No. 63/077,964, filed on Sep. 14, 2020.

(51) Int. Cl. B23K 26/38; G02B 6/10; B23K 26/402

(52) U.S. Cl. CPC B23K 26/38; B23K 26/402; G02B 6/10

(57) ABSTRACT

Cutting a wafer having devices, such as glass optical waveguides, into die by cutting into both sides of the wafer to reduce or eliminate micro-cracks and defects in the die. The wafer can be cut by simultaneously cutting the wafer from both sides using separate lasers at a controlled depth. The wafer can also be sequentially cut by cutting into one side of the wafer, flipping the wafer, and then cutting into the other side of the wafer. A processor controls the power of each laser to select the depth of each cut, such that each cut may be 50% into the wafer, or other depths such as 30% for one cut and 70% for the other cut. The wafer may be cut into the bottom surface of the wafer first, and then cut into the top surface of the wafer having the optical waveguides.

### CROSS-REFERENCE TO RELATED APPLICATIONS

This application claims priority to U.S. Provisional Application Ser. No. 63/077,964 filed on Sep. 14, 2020, the contents of which are incorporated fully herein by reference.

### TECHNICAL FIELD

The present subject matter relates to optical waveguides used in a display, such as for an eyewear device including smart glasses and headwear.

### BACKGROUND

Optical waveguides may be formed using wafer processing techniques which may create defects.

### BRIEF DESCRIPTION OF THE DRAWINGS

The drawing figures depict one or more implementations, by way of example only, not by way of limitations. In the figures, like reference numerals refer to the same or similar elements.

FIG. 1 illustrates a wafer having a plurality of devices formed on a top surface, such as glass waveguides;

FIG. 2 is a cross section taken along line 2-2 in FIG. 1 illustrating the wafer thickness;

FIG. 3 illustrates a first example of cutting the wafer into die by simultaneously cutting into the wafer from both sides of the wafer;

FIG. 4 is a hardware diagram of a cutting apparatus;

FIG. 5 illustrates a second example of cutting the wafer into die by sequentially cutting into the wafer from one side, flipping the wafer, and then cutting into the wafer from the other side to completely cut the wafer; and

FIG. 6 is a flowchart of a method of cutting the wafer.

### DETAILED DESCRIPTION

This disclosure includes examples of cutting a wafer having devices, such as glass optical waveguides, into die by cutting into both sides of the wafer to reduce or eliminate micro-cracks and defects in the die. The wafer can be cut by simultaneously cutting the wafer from both sides using separate lasers at a controlled depth. The wafer can also be sequentially cut by cutting into one side of the wafer, flipping the wafer, and then cutting into the other side of the wafer. A processor controls the power of each laser to select the depth of each cut, such that each cut may be 50% into the wafer, or other depths such as 30% for one cut and 70% for the other cut. The wafer may be cut into the bottom surface of the wafer first, and then cut into the top surface of the wafer having the optical waveguides.

Additional objects, advantages and novel features of the examples will be set forth in part in the description which follows, and in part will become apparent to those skilled in the art upon examination of the following and the accompanying drawings or may be learned by production or operation of the examples. The objects and advantages of the present subject matter may be realized and attained by means of the methodologies, instrumentalities and combinations particularly pointed out in the appended claims.

In the following detailed description, numerous specific details are set forth by way of examples in order to provide a thorough understanding of the relevant teachings. However, it should be apparent to those skilled in the art that the present teachings may be practiced without such details. In other instances, well known methods, procedures, components, and circuitry have been described at a relatively high-level, without detail, in order to avoid unnecessarily obscuring aspects of the present teachings.

The term “coupled” as used herein refers to any logical, optical, physical or electrical connection, link or the like by which signals or light produced or supplied by one system element are imparted to another coupled element. Unless described otherwise, coupled elements or devices are not necessarily directly connected to one another and may be separated by intermediate components, elements or communication media that may modify, manipulate or carry the light or signals.

The orientations of the eyewear device, associated components and any complete devices incorporating an eye scanner and camera such as shown in any of the drawings, are given by way of example only, for illustration and discussion purposes. In operation for a particular variable optical processing application, the eyewear device may be oriented in any other direction suitable to the particular application of the eyewear device, for example up, down, sideways, or any other orientation. Also, to the extent used herein, any directional term, such as front, rear, inwards, outwards, towards, left, right, lateral, longitudinal, up, down, upper, lower, top, bottom and side, are used by way of example only, and are not limiting as to direction or orientation of any optic or component of an optic constructed as otherwise described herein.

Reference now is made in detail to the examples illustrated in the accompanying drawings and discussed below.

Glass substrates used in optical waveguide stacks are not chemically strengthened as typically seen in glass covers of mobile phones and tablets. This results in a relatively poor drop test performance where the glass substrate waveguides end up breaking at very short drop heights making it challenging to meet product reliability requirements. Waveguides are typically processed at a wafer level, i.e. there are multiple waveguide dies formed in a glass wafer. Post fabrication and coating processes, the waveguides are singulated into individual dies for further downstream processing and packaging.

One parameter impacting glass strength is any micro-cracks or flaws generated in the glass during the cutting and singulation process, referred to as dicing. These micro-cracks and flaws are the typical points of failure from where glass breakage occurs. The inability to use chemically strengthened glass, or strengthen the glass post singulation, makes it critical to ensure micro-cracks and flaws in the glass are minimized during the cutting and singulation process.

Glass wafer cutting can be achieved via a laser, a typical process used in the industry. In current waveguide designs, 4-point bend tests (measure of glass strength) indicate lower B10 life of glass (time when 10% will fail) for the side of glass where laser entry takes place vs. the side of the glass where there laser exits by ˜20%. When the laser cuts though the entire glass thickness from one side of the wafer, it requires higher laser power which creates larger micro-cracks and flaws at the laser entry point.

This disclosure eliminates the laser cutting process of completely cutting the glass from one side, which requires higher laser power to go through the entire substrate thickness (in the range of 0.3-1 mm typically) which in turn generates larger micro-cracks and flaws.

In one example, a double-sided laser cutting process is used for singulation to cut the wafer from both sides of the glass, simultaneously. This process uses lower laser power for cutting partially into the wafer to a depth from each side to obtain a complete cut than compared to completely cutting the glass in one step, as the laser needs to partially penetrate the glass thickness, such as one-half the thickness. In another example, the laser cuts the wafer from the waveguide side of the wafer to a depth less than halfway through the die, such as 30%, and the laser cuts from the opposing wafer side to a depth more than halfway, such as 70%. By cutting into the wafer at a depth of less than halfway into the wafer from the side having the optical waveguides, any micro-cracks and flaws may be reduced even more.

In another example, the laser first cuts partially into the glass thickness from one side. The wafer is then flipped, or the laser is flipped, and the laser cuts through the remaining portion of the glass thickness from the opposite side, which again reduces the laser power requirement. In one example, the laser cuts 50% into the wafer from both sides, and in another example the laser cuts to different depths into the wafer as previously discussed. The lower laser power requirement reduces the size of any micro-cracks and flaws generated during entry, thereby improving glass strength and overall product drop test performance. At least a 20% gain in glass strength is achieved. Challenges to strengthen the waveguide glass either chemically or via mechanical polishing post singulation make it a more unique challenge for waveguide glass substrates vs other glass substrates used in the industry which may not have similar constraints. The processes described allows the elimination of polishing post singulation, or reduces the time of polishing.

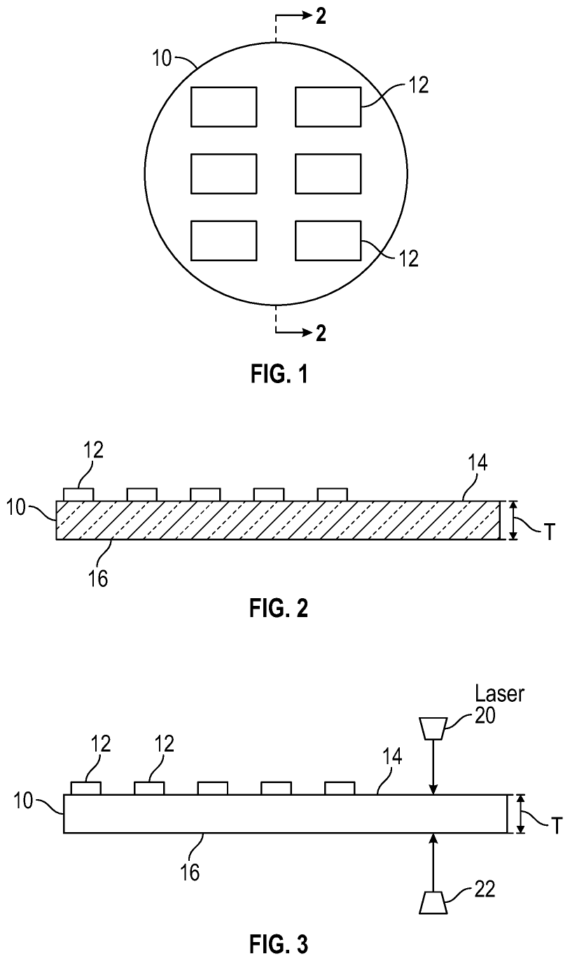

Referring to FIG. 1, there is shown a circular wafer 10 having a plurality of devices 12, such as optical waveguides, formed on a top surface 14 of the wafer 10 using conventional wafer processing techniques. The wafer is comprised of glass as is the optical waveguides 12. In another example, the wafer comprises another material, such as silicon. The wafer 10 has a bottom surface 16 and a wafer thickness T. The wafer 10 has a diameter defining an area of the top surface 14 where multiple waveguides 12 are formed during processing, such as 200 mm or 300 mm, although limitation to the size of the wafer 10 is not to be inferred.

FIG. 2 illustrates a cross section of wafer 10 taken along line 2-2 in FIG. 1 illustrating the wafer thickness T of the glass wafer 10. Wafer thickness T is typically between 0.3 mm and 1.0 mm, although this wafer thickness T can vary depending on numerous processing parameters. For instance, the greater the thickness of the wafer the greater the strength of the formed waveguides 12 when diced and the better the resulting drop test performance. However, the greater the wafer thickness the greater the laser energy required to cut into the wafer 10 and the more micro-cracks and flaws formed proximate the cut, as well as the greater the weight of the waveguides 12.

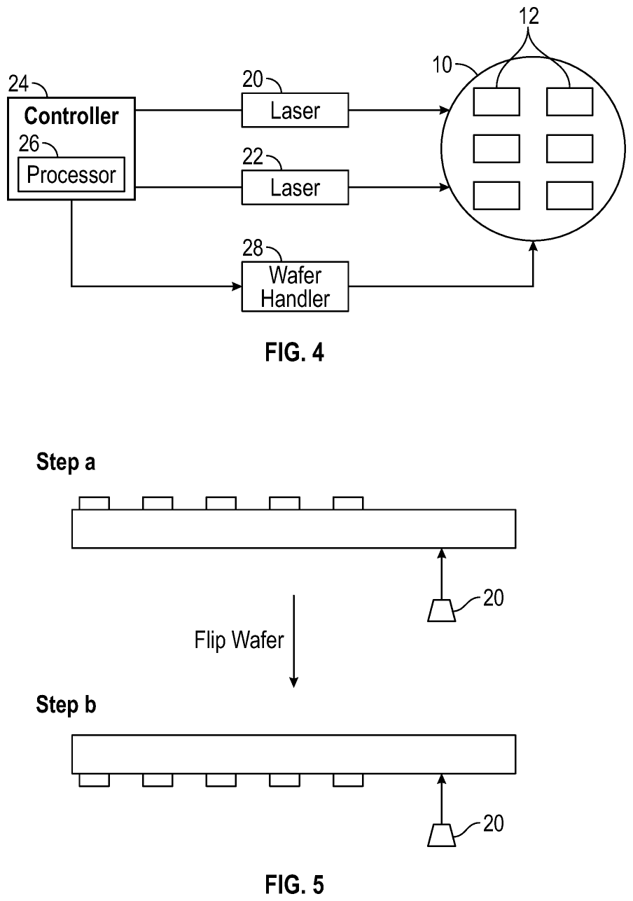

FIG. 3 illustrates a first example of cutting the wafer 10 to singulate or dice the waveguides 12 into dies by simultaneously laser cutting the wafer 10 from both sides of the wafer. A laser 20 is shown positioned proximate the top surface 14 of the wafer 10, and a laser 22 is positioned proximate a bottom surface 16, where each laser 20 and 22 is controlled by a laser controller 24 having an electronic processor 26, as shown in FIG. 4. The processer 26 controls the power of each laser 20 and 22 such that each laser cuts a predetermined depth into the wafer 10 as a function of the laser power, as well duration of the cut, to completely cut the wafer. As previously described, each laser can cut halfway into the wafer 10, such that each laser cuts 50% of the wafer. In other examples, the laser 20 cuts into the wafer top surface 14 less than halfway through the wafer 10, such as 30%, and the laser 22 cuts into the wafer bottom surface 16 more than halfway, such as 70%. By cutting into the wafer top surface 14 having the waveguides 12 less than halfway, any micro-cracks and flaws are reduced even more. The lasers 20 and 22 are precisely aligned to create a straight cut.

By separately cutting into the wafer 10, post-cutting polishing can be eliminated, or shortened in time, which reduces processing time.

FIG. 5 illustrates another example of cutting the wafer 10 to singulate or dice the waveguides 12 into dies by first laser cutting into the wafer 10 from one side of the wafer with laser 20, flipping the wafer 10 with a wafer handler 28, or flipping the laser 20, controlled by processor 26, and then cutting into the wafer 10 from the other side of the wafer. In one example, the laser 20 first cuts into the wafer bottom surface 16, and then cuts into the wafer top surface 14 to complete the cut and dicing. The order of cutting can be reversed. However, cutting into the bottom surface 16 first can reduce the micro-cracks and defects proximate the waveguide 12. Laser 20 is shown in a fixed position, wherein the wafer handler 28 positions the wafer 10 for each cut. The processer 26 controls the power of laser 20 for each cut such that laser 20 cuts a predetermined depth into the wafer 10. The laser 20 can cut halfway into the wafer 10 for the first cut such that the laser 20 cuts 50% into the wafer. When the wafer 10 is flipped by the wafer handler 28, or the laser 20 is flipped, the laser 20 then cuts into the wafer top surface 14 the other 50%. In another example, the laser 20 may cut less than halfway into the wafer 10 for one side, such as 30%, and the laser 20 cuts into the other side of the wafer more than halfway, such as 70%.

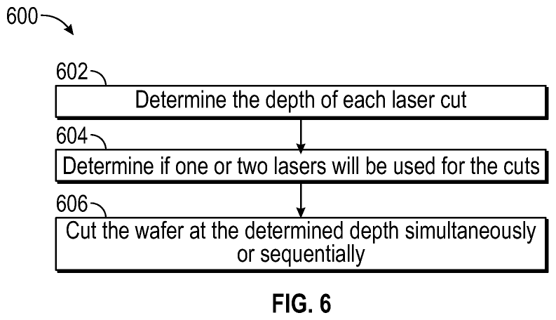

FIG. 6 illustrates a flowchart 600 executed by processor 26 to cut the wafer 10 from both sides of the wafer.

At block 602, the processor 26 selects the depth of each cut into the wafer 10 from each side of the wafer. A user may program the processor 26 to select the cut depths. For example, the processor 26 may select the first cut to be 50% into the wafer 10 from each side. In another example, the processor may select the first cut to be 30% into the wafer 10, and the second cut to be 70% into the wafer 10.

At block 604, the processor 26 determines if one or two lasers will be used. For instance, in the example as described with reference to FIG. 3, the processor may determine to simultaneously cut into the wafer 10 from both sides of the wafer 10 using both laser 20 and laser 22. In the example as described with reference to FIG. 5, the processor may determine to cut the wafer 10 one side at a time using the same laser 20.

At block 606, the processor 26 controls laser 20 and laser 22 to cut into the wafer 10 from both sides of the wafer 10. The processor 26 cuts into the wafer 10 from both sides of the wafer simultaneously using both lasers 20 and 22 as illustrated in FIG. 3, or sequentially as illustrated in FIG. 5 by first cutting into one side of the wafer 10 using laser 20, then flipping the wafer 10 using the wafer handler 28, or flipping laser 20, and then cutting into the other side of the wafer using the same laser 20 as described. The processor 26 sets the power of the laser 20, and laser 22 when used, such that the lasers cut into the wafer 10 the predetermined depth established in block 602.

It will be understood that the terms and expressions used herein have the ordinary meaning as is accorded to such terms and expressions with respect to their corresponding respective areas of inquiry and study except where specific meanings have otherwise been set forth herein. Relational terms such as first and second and the like may be used solely to distinguish one entity or action from another without necessarily requiring or implying any actual such relationship or order between such entities or actions. The terms “comprises,” “comprising,” “includes,” “including,” or any other variation thereof, are intended to cover a non-exclusive inclusion, such that a process, method, article, or apparatus that comprises or includes a list of elements or steps does not include only those elements or steps but may include other elements or steps not expressly listed or inherent to such process, method, article, or apparatus. An element preceded by “a” or “an” does not, without further constraints, preclude the existence of additional identical elements in the process, method, article, or apparatus that comprises the element.

Unless otherwise stated, any and all measurements, values, ratings, positions, magnitudes, sizes, and other specifications that are set forth in this specification, including in the claims that follow, are approximate, not exact. Such amounts are intended to have a reasonable range that is consistent with the functions to which they relate and with what is customary in the art to which they pertain. For example, unless expressly stated otherwise, a parameter value or the like may vary by as much as ±10% from the stated amount.

In addition, in the foregoing Detailed Description, it can be seen that various features are grouped together in various examples for the purpose of streamlining the disclosure. This method of disclosure is not to be interpreted as reflecting an intention that the claimed examples require more features than are expressly recited in each claim. Rather, as the following claims reflect, the subject matter to be protected lies in less than all features of any single disclosed example. Thus, the following claims are hereby incorporated into the Detailed Description, with each claim standing on its own as a separately claimed subject matter.

While the foregoing has described what are considered to be the best mode and other examples, it is understood that various modifications may be made therein and that the subject matter disclosed herein may be implemented in various forms and examples, and that they may be applied in numerous applications, only some of which have been described herein. It is intended by the following claims to claim any and all modifications and variations that fall within the true scope of the present concepts.

What is claimed is:

1. A device formed by a wafer process, comprising:
forming an optical waveguide on a wafer comprising a substrate having a first side and an opposing second side;
cutting the wafer by cutting into, but not through, the substrate from the first side of the substrate a first distance; and
cutting the wafer by cutting into, but not through, the substrate from the second side of the substrate a second distance such that the optical waveguide is separated into a die.

2. The device as specified in claim 1, wherein the wafer is cut using at least one laser.

3. The device as specified in claim 1, wherein the wafer is comprised of glass.

4. The device as specified in claim 3, further comprising the process of cutting into the first side the first distance simultaneously while cutting into the second side the second distance.

5. The device as specified in claim 4, further comprising the process of cutting into the first side and the second side simultaneously using two lasers.

6. The device as specified in claim 5, wherein the two lasers operate at different power.

7. The device as specified in claim 3, further comprising the process of cutting into the first side the first distance, and then cutting into the second side the second distance.

8. The device as specified in claim 7, further comprising the process of cutting into the first side and the second side sequentially using a single laser.

9. The device as specified in claim 1, further comprising the process of cutting into the first side such that the first distance is equal to the second distance the wafer is cut into the second side.

10. The device as specified in claim 1, further comprising the process of cutting into the first side such that the first distance is unequal to the second distance the wafer is cut into the second side.

11. A method of processing a wafer, comprising:
forming an optical waveguide on a wafer comprising a substrate having a first side and an opposing second side;
cutting the wafer by cutting into, but not through, the substrate from the first side of the substrate a first distance; and
cutting the wafer by cutting into, but not through, the substrate from the second side of the substrate a second distance such that the optical waveguide is separated into a die.

12. The method as specified in claim 11, wherein the wafer is cut using at least one laser.

13. The method as specified in claim 11, wherein the wafer is comprised of glass.

14. The method as specified in claim 13, further comprising cutting into the first side the first distance simultaneously while cutting into the second side the second distance.

15. The method as specified in claim 14, further comprising cutting into the first side and the second side simultaneously using two lasers.

16. The method as specified in claim 15, wherein the two lasers operate at different power.

17. The method as specified in claim 13, further comprising cutting into the first side the first distance, and then cutting into the second side the second distance.

18. The method as specified in claim 17, further comprising cutting into the first side and the second side sequentially using a single laser.

19. The method as specified in claim 11, further comprising cutting into the first side such that the first distance is equal to the second distance the wafer is cut into the second side.

20. The method as specified in claim 11, further comprising cutting into the first side such that the first distance is unequal to the second distance the wafer is cut into the second side.
